(19) United States
(12) Patent Application Publication
(10) Pub. No.: US 2018/0178620 A1
(43) Pub. Date: Jun. 28, 2018

(54) AIRFLOW CONTROL ASSEMBLY FOR AN HVAC SYSTEM OF A WORK VEHICLE

(71) Applicant: CNH Industrial America LLC, New Holland, PA (US)

(72) Inventors: Doriano Ferri, Brussels (BE); Joaquim Guitart Corominas, Barcelona (ES); John Edward Burnham, Batavia, IL (US)

(21) Appl. No.: 15/391,533

(22) Filed: Dec. 27, 2016

(51) Int. Cl. B60H 1/00

(52) U.S. Cl. CPC B60H 1/00378; B60H 1/00671; B60H 1/00021; B60H 2001/00607; B60Y 2306/05; B60Y 2306/07; B60Y 2200/22

(57) ABSTRACT

An airflow control assembly for an HVAC system of a work vehicle includes a body having a first inlet configured to receive a first airflow, a second inlet configured to receive a second airflow, and an outlet configured to output a third airflow. The airflow control assembly also includes an arcuate door disposed within the body. The arcuate door is configured to rotate relative to the body to control the first airflow through the first inlet and the second airflow through the second inlet. In addition, a width of the first inlet increases from a first circumferential end of the first inlet to a transition point between the first circumferential end and a second circumferential end of the first inlet, and the width of the first inlet decreases from the transition point to the second circumferential end of the first inlet.

### BACKGROUND

The present disclosure relates generally to an airflow control assembly for an HVAC system of a work vehicle.

Certain work vehicles (e.g., tractors, harvesters, skid steers, etc.) include a heating, ventilation, and air condition (HVAC) system configured to control an air temperature within a cab of the work vehicle. In addition, the HVAC system may be configured to pressurize the cab to substantially reduce ingress of dirt and/or other contaminants, to enhance passenger comfort, to reduce noise, or a combination thereof. Certain HVAC systems include an airflow control assembly configured to mix external air from an environment external to the cab with recirculated air from an interior of the cab. The pressurization of the cab may be controlled at least in part by controlling the mixing of the external air and the recirculated air. For example, the airflow control assembly may include a first inlet configured to receive the external air and a second inlet configured to receive the recirculated air. In addition, the airflow control assembly may include a door configured to move between a first position in which the door substantially blocks the first inlet, a second position in which the door substantially blocks the second inlet, and a third position in which the door partially blocks the first and second inlets. Unfortunately, due to the shape of typical doors and/or typical inlets, it may be difficult to accurately control the pressure within the cab by adjusting the position of the door.

### BRIEF DESCRIPTION

In one embodiment, an airflow control assembly for an HVAC system of a work vehicle includes a body having a first inlet configured to receive a first airflow from an environment external to a cab of the work vehicle, a second inlet configured to receive a second airflow from an interior of the cab of the work vehicle, and an outlet configured to output a third airflow to the interior of the cab of the work vehicle. The airflow control assembly also includes an arcuate door disposed within the body. The arcuate door is configured to rotate relative to the body to control the first airflow through the first inlet and the second airflow through the second inlet. In addition, a width of the first inlet increases from a first circumferential end of the first inlet to a transition point between the first circumferential end and a second circumferential end of the first inlet, and the width of the first inlet decreases from the transition point to the second circumferential end of the first inlet.

In another embodiment, an airflow control assembly for an HVAC system of a work vehicle includes a body having a first inlet configured to receive a first airflow from an environment external to a cab of the work vehicle, a second inlet configured to receive a second airflow from an interior of the cab of the work vehicle, and an outlet configured to output a third airflow to the interior of the cab of the work vehicle. The first inlet, the second inlet, and the outlet are arranged along a circumferential axis of the body and are spaced apart from one another along the circumferential axis. The airflow control assembly also includes an arcuate door disposed within the body. The arcuate door includes a central portion extending along a longitudinal axis of the body between a pair of end portions, the arcuate door is configured to rotate relative to the body along the circumferential axis between at least a first position, a second position, and a third position, the central portion of the arcuate door is configured to substantially block the first airflow through the first inlet while the arcuate door is in the first position, the central portion of the arcuate door is configured to substantially block the second airflow through the second inlet while the arcuate door is in the second position, and the central portion of the arcuate door is configured to partially block the first airflow through the first inlet and to partially block the second airflow through the second inlet while the arcuate door is in the third position. In addition, a width of the first inlet along the longitudinal axis increases from a first circumferential end of the first inlet to a transition point between the first circumferential end and a second circumferential end of the first inlet, and the width of the first inlet along the longitudinal axis decreases from the transition point to the second circumferential end of the first inlet.

In a further embodiment, an airflow control assembly for an HVAC system of a work vehicle includes a body having a first inlet configured to receive a first airflow from an environment external to a cab of the work vehicle, a second inlet configured to receive a second airflow from an interior of the cab of the work vehicle, and an outlet configured to output a third airflow to the interior of the cab of the work vehicle. The airflow control system also includes an arcuate door disposed within the body. The arcuate door is configured to rotate relative to the body between at least a first position, a second position, and a third position, the arcuate door is configured to substantially block the first airflow through the first inlet while the arcuate door is in the first position, the arcuate door is configured to substantially block the second airflow through the second inlet while the arcuate door is in the second position, and the arcuate door is configured to partially block the first airflow through the first inlet and to partially block the second airflow through the second inlet while the arcuate door is in the third position. In addition, a width of the first inlet increases from a first circumferential end of the first inlet to a transition point between the first circumferential end and a second circumferential end of the first inlet, and the width of the first inlet decreases from the transition point to the second circumferential end of the first inlet.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that may include an HVAC system having an airflow control assembly;

FIG. 2 is a schematic diagram of an embodiment of an HVAC system that may be employed within the work vehicle of FIG. 1;

FIG. 3 is a front perspective view of an embodiment of an airflow control assembly that may be employed within the HVAC system of FIG. 2;

FIG. 4 is a front view of the airflow control assembly of FIG. 3;

FIG. 5 is a back perspective view of the airflow control assembly of FIG. 3;

FIG. 6 is a back view of the airflow control assembly of FIG. 3;

FIG. 7 is an exploded perspective view of a portion of the airflow control assembly of FIG. 3;

FIG. 8 is a cross-sectional perspective view of the airflow control assembly of FIG. 3, taken along line 8-8 of FIG. 5, in which a door is in a first position;

FIG. 9 is a cross-sectional perspective view of the airflow control assembly of FIG. 3, in which the door is in a second position; and

FIG. 10 is a cross-sectional perspective view of the airflow control assembly of FIG. 3, in which the door is in a third position.

### DETAILED DESCRIPTION

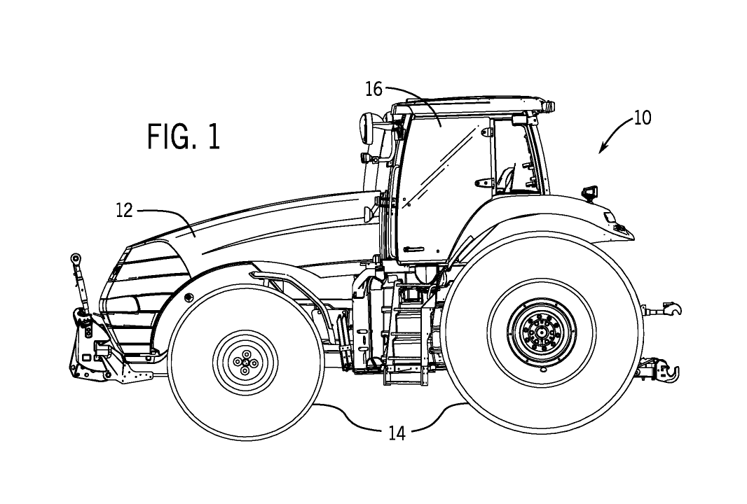

Turn now to the drawings, FIG. 1 is a side view of an embodiment of a work vehicle 10 that may include a heating, ventilation, and air conditioning (HVAC) system having an airflow control assembly. In the illustrated embodiment, the work vehicle 10 includes a body 12 configured to house an engine, a transmission, other systems of the work vehicle 10, or a combination thereof. In addition, the work vehicle 10 includes wheels 14 configured to be driven by the engine and transmission, thereby driving the work vehicle 10 along a field, a road, or any other suitable surface. In the illustrated embodiment, the work vehicle 10 includes a cab 16 configured to house an operator. As discussed in detail below, the work vehicle may include an HVAC system configured to control an air temperature within the cab and/or to pressurize the cab. Pressurizing the cab may substantially reduce ingress of dirt and/or other contaminants, enhance passenger comfort, reduce noise, or a combination thereof. In certain embodiments, the HVAC system includes an airflow control assembly configured to control mixing of external air from an environment external to the cab with recirculated air from an interior of the cab, thereby controlling the air pressure within the cab. While the illustrated work vehicle 10 is a tractor, it should be appreciated that the HVAC system disclosed herein may be employed within any suitable work vehicle, such as a harvester, a sprayer, or a skid steer.

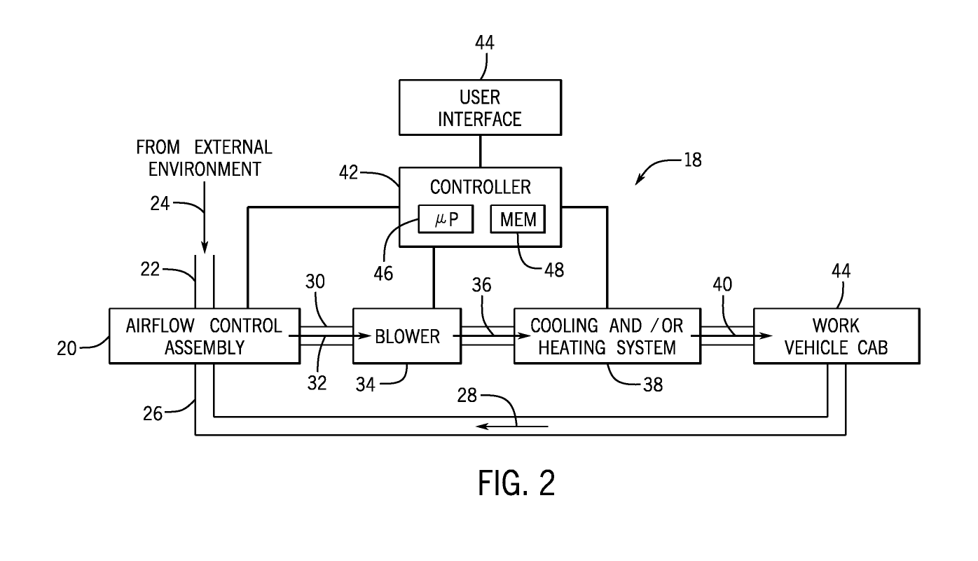

FIG. 2 is a schematic diagram of an embodiment of an HVAC system 18 that may be employed within the work vehicle of FIG. 1. In the illustrated embodiment, the HVAC system 18 includes an airflow control assembly 20 configured to control mixing of external air from an environment external to the cab with recirculated air from an interior of the cab. The airflow control assembly 20 includes a body having a first inlet 22 configured to receive a first airflow 24 (e.g., external air) from the environment external to the cab 16, and a second inlet 26 configured to receive a second airflow 28 (e.g., recirculated air) from the interior of the cab 16. The body of the airflow control assembly 20 also includes an outlet 30 configured to output a third airflow 32 to the interior of the cab 16. In certain embodiments, the airflow control assembly includes an arcuate door disposed within the body and configured to rotate relative to the body to control the first airflow through the first inlet and the second airflow through the second inlet, thereby controlling the mixture of the external air and the recirculated air.

In the illustrated embodiment, the HVAC system 18 includes a blower 34 configured to receive the third airflow 32 from the airflow control assembly 20 and to output a fourth airflow 36 to the work vehicle cab 16. In addition, a cooling and/or heating system 38 is configured to receive the fourth airflow 36 and to output a fifth airflow 40 having a higher or lower temperature than the fourth airflow 36. As illustrated, the fifth airflow 40 flows into the cab 16 of the work vehicle. During certain operating conditions, the cooling and/or heating system 38 may be deactivated. As a result, the temperature of the fifth airflow 40 may be substantially equal to the temperature of the fourth airflow 36. The heating and/or cooling system 38 may include a heater core of a heating system and/or an evaporator of a refrigeration system, among other heating and/or cooling devices/systems. In certain embodiments, the cooling and/or heating system may be omitted, and the fourth airflow may flow directly into the cab 16.

In the illustrated embodiment, the HVAC system 18 includes a controller 42 communicatively coupled to the airflow control assembly 20, the blower 34, and the cooling and/or heating system 38. The controller 42 may be configured to instruct an actuator of the airflow control assembly to control a position of the arcuate door, thereby controlling the mixing of the external air and the recirculated air. In addition, the controller may be configured to control an output of the blower, thereby controlling a flow rate of the airflow into the cab. The controller may also be configured to control the cooling and/or heating system to control the temperature of the airflow into the cab. In the illustrated embodiment, the controller 42 is communicatively coupled to a user interface 44. The user interface 44 may be located within the cab of the work vehicle and configured to receive input from the operator, such as input for controlling the airflow control assembly, the blower, the cooling and/or heating system, or a combination thereof.

In certain embodiments, the controller 42 is an electronic controller having electrical circuitry configured to process data from certain components of the HVAC system 18, such as the user interface 44. In the illustrated embodiment, the controller 42 include a processor, such as the illustrated microprocessor 46, and a memory device 48. The controller 42 may also include one or more storage devices and/or other suitable components. The processor 46 may be used to execute software, such as software for controlling the HVAC system, and so forth. Moreover, the processor 46 may include multiple microprocessors, one or more “general-purpose” microprocessors, one or more special-purpose microprocessors, and/or one or more application specific integrated circuits (ASICS), or some combination thereof. For example, the processor 46 may include one or more reduced instruction set (RISC) processors.

The memory device 48 may include a volatile memory, such as random access memory (RAM), and/or a nonvolatile memory, such as read-only memory (ROM). The memory device 48 may store a variety of information and may be used for various purposes. For example, the memory device 48 may store processor-executable instructions (e.g., firmware or software) for the processor 46 to execute, such as instructions for controlling the HVAC system, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the HVAC, etc.), and any other suitable data.

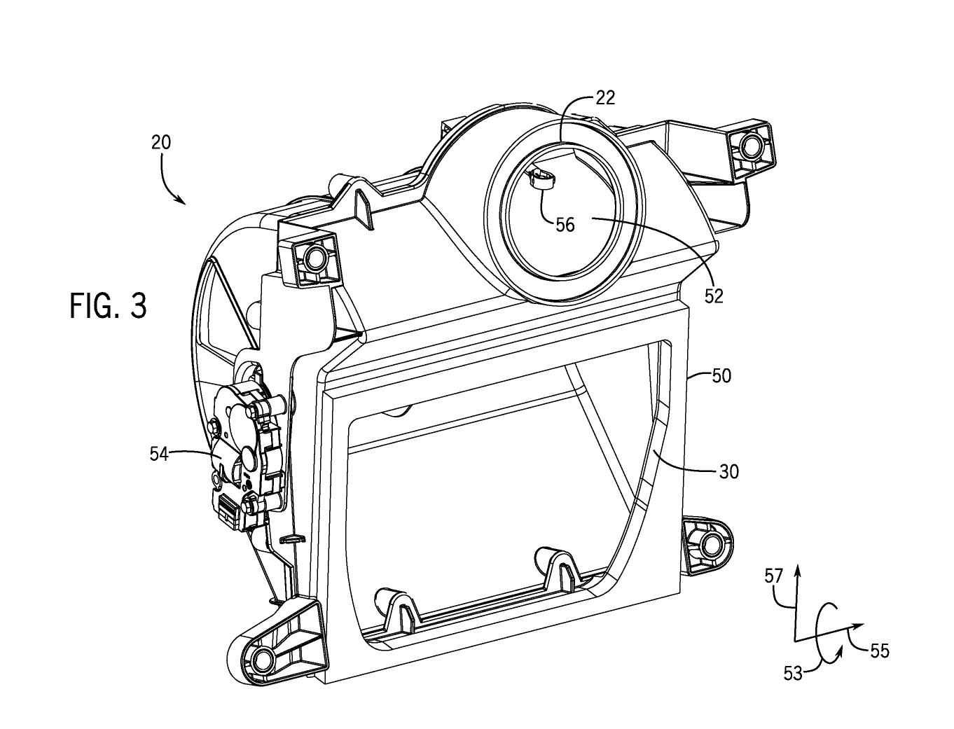

FIG. 3 is a front perspective view of an embodiment of an airflow control assembly 20 that may be employed within the HVAC system of FIG. 2. In the illustrated embodiment, the airflow control assembly 20 includes a body 50 having the first inlet 22, the second inlet, and the outlet 30. As previously discussed, the first inlet 22 is configured to receive the first airflow (e.g., external air) from the environment external to the cab of the work vehicle. In addition, the second inlet is configured to receive the second airflow (e.g., recirculated air) from the interior of the cab of the work vehicle, and the outlet 30 is configured to output the third airflow to the interior of the cab. The airflow control assembly 20 also includes a door, such as the illustrated arcuate door 52, disposed within the body 50. In the illustrated embodiment, the arcuate door extends along a circumferential axis 53 and along a longitudinal axis 55. As discussed in detail below, the arcuate door 52 is rotatably coupled to the body 50 by a pair of end portions that extend along a radial axis 57. The arcuate door 52 is configured to rotate along the circumferential axis 53 relative to the body 50 to control the first airflow through the first inlet 22 and the second airflow through the second inlet, thereby controlling the mixing of the external air and the recirculated air. The resultant airflow (e.g., third airflow) exits through the outlet 30 and flows to the interior of the cab of the work vehicle.

In the illustrated embodiment, the airflow control assembly 20 includes an actuator 54 coupled to the arcuate door 52. The actuator 54 is configured to drive the arcuate door to rotate along the circumferential axis 53 relative to the body 50. In certain embodiments, the actuator is communicatively coupled to the controller, and the controller is configured to instruct the actuator to adjust the position of the door relative to the body, thereby controlling the mixing of the external air and the recirculated air. The controller may instruct the actuator to adjust the position of the door based on manual input (e.g., from the user interface) and/or based on input from certain sensor(s) (e.g., air temperature senor(s), air pressure sensor(s), etc.). For example, in the illustrated embodiment, the airflow control assembly 20 includes an air temperature sensor 56 mounted proximate to the first inlet 22 and configured to output a signal indicative of a temperature of the external air. In the illustrated embodiment, the actuator 54 is an electromechanical actuator. However, it should be appreciated that in certain embodiments, the actuator may be a hydraulic actuator, a pneumatic actuator, or any other suitable type of actuator. Furthermore, in certain embodiments, the actuator may be omitted and an operator may manually control the position of the door (e.g., via a lever, a handle, etc.).

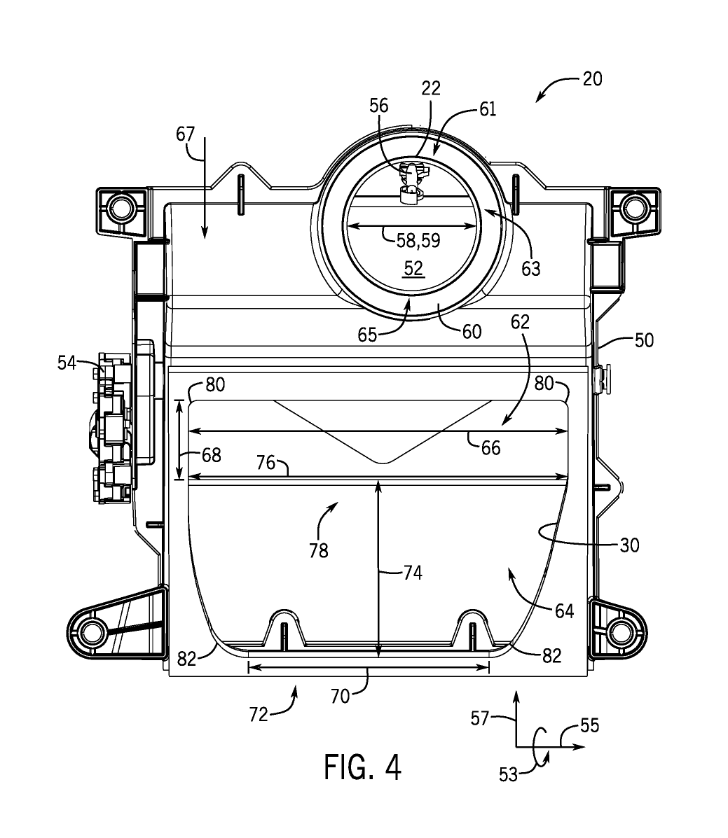

FIG. 4 is a front view of the airflow control assembly 20 of FIG. 3. As illustrated, the first inlet 22 of the body 50 is substantially circular. That is, the first inlet has a substantially circular shape. Accordingly, a width 58 (e.g., extent along the longitudinal axis 555) of the first inlet 22 increases along the circumferential axis 53 (e.g., relative to a rotational direction 67 of the arcuate door from the second position toward the first position) from a first circumferential end 61 of the first inlet 22 to a transition point 63, which is positioned between the first circumferential end 61 and a second circumferential end 65 of the first inlet 22. In addition, the width 58 of the first inlet 22 decreases from the transition point 63 to the second circumferential end 65 along the circumferential axis 53 (e.g., relative to the rotational direction 67 of the arcuate door from the second position toward the first position). A diameter 59 of the first inlet 22 (e.g., the width 58 of the first inlet 22 at the transition point 63) may be particularly selected to establish a desired flow rate of the first airflow into the body 50 (e.g., relative to a flow rate of the second airflow, based on the position of the arcuate door, etc.). In the illustrated embodiment, the body 50 includes a recess 60 around the inlet 22 to facilitate coupling an intake tube or hose to the body 50.

While the illustrated first inlet 22 is substantially circular, it should be appreciated that in certain embodiments, the first inlet may be any suitable shape in which the width of the inlet increases from the first circumferential end to the transition point and decreases from the transition point to the second circumferential end. For example, in certain embodiments, the first inlet may be elliptical, oval-shaped, diamond-shaped, or polygonal (e.g., octagonal, hexagonal, etc.). Furthermore, while a first portion of the first inlet 22 between the first circumferential end 61 and the transition point 63 is substantially symmetrical to a second portion of the first inlet between the transition point 63 and the second circumferential end 65, it should be appreciated that in alternative embodiments, the first and second portions may not be symmetrical and/or may have differential shapes. In embodiments in which the first inlet is not circular, the shape and/or size of the first inlet may be particularly selected to establish a desired flow rate of the first airflow into the body 50 (e.g., relative to a flow rate of the second airflow, based on the position of the arcuate door, etc.).

As discussed in detail below, moving the arcuate door 52 relative to the body 50 controls mixing of the external air with the recirculated air, thereby controlling the air pressure within the cab. With the arcuate door 52 in the illustrated first position, the arcuate door 52 substantially blocks the first airflow through the first inlet 22 and enables the second airflow to flow through the second inlet. In addition, with the arcuate door in the second position, the arcuate door substantially blocks the second airflow through the second inlet and enables the first airflow to flow through the first inlet. And, with the arcuate door in a third position between the first and second positions, the arcuate door partially blocks the first airflow through the first inlet and partially blocks the second airflow through the second inlet. Accordingly, moving the door between the first and second positions controls the flow of external air into the cab, thereby controlling the air pressure within the interior of the cab. For example, the controller may instruct the actuator 54 to move the arcuate door 52 to control the air pressure within the interior of the cab. Because the width of the first inlet 22 increases from the first circumferential end to the transition point and decreases between the transition point and the second circumferential end, moving the arcuate door 52 between the first and second positions may produce a substantially linear change in cab pressurization. As a result, controlling the air pressure within the interior of the cab may be significantly less complex than controlling cab pressurization with an airflow control assembly having a non-linear relationship between door position and cab pressurization (e.g., an airflow control assembly having a body with a substantially rectangular external air inlet).

In the illustrated embodiment, the outlet 30 has a first portion 62 with a substantially rectangular shape and a second portion 64 with a substantially trapezoidal shape. A longitudinal extent 66 (e.g., extent along the longitudinal axis 55) and a circumferential extent 68 (e.g., extend along the circumferential axis 53) of the first portion 62 may be particularly selected to establish a desired flow rate of the third airflow through the outlet 30 (e.g., relative to flow rate(s) of the first and/or second airflows, based on the position of the arcuate door, etc.). In addition, a longitudinal extent 70 (e.g., extent along the longitudinal axis 55) of a first circumferential end 72 of the second portion 64 and a circumferential extent 74 (e.g., extent along the circumferential axis 53) of the second portion 64 may be particularly selected to establish a desired flow rate of the third airflow through the outlet 30 (e.g., relative to flow rate(s) of the first and/or second airflows, based on the position of the arcuate door, etc.). As illustrated, a longitudinal extent 76 (e.g., extent along the longitudinal axis 55) of a second end 78 of the second portion 64 is substantially equal to the longitudinal extent 66 of the first portion 62. In the illustrated embodiment, corners 80 of the first portion 62 and corners 82 of the second portion 64 are rounded. However, it should be appreciated that in alternative embodiments, one or more of the corners may be angled. In addition, it should be appreciated that the radius of curvature of each corner may be particularly selected to establish a desired flow rate of the third airflow through the outlet 30 (e.g., relative to flow rate(s) of the first and/or second airflows, based on the position of the arcuate door, etc.).

While the illustrated outlet 30 includes a first portion 62 having a substantially rectangular shape and a second portion 64 having a substantially trapezoidal shape, it should be appreciated that in alternative embodiments, the outlet may have other shapes and/or configurations. For example, in certain embodiments, the outlet may include a single portion (e.g., having a substantially rectangular shape, a substantially trapezoidal shape, a substantially elliptical shape, etc.). In further embodiments, the outlet may include 3, 4, 5, 6, or more portions (e.g., each portion having a different shape). In addition, while the illustrated first portion has a substantially rectangular shape, it should be appreciated that in alternative embodiments, the first portion may have a substantially trapezoidal shape, a substantially semi-elliptical shape, or a substantially semi-circular shape, among others. Furthermore, while the illustrated second portion has a substantially trapezoidal shape, it should be appreciated that in alternative embodiments, the second portion may have a substantially rectangular shape, a substantially semi-elliptical shape, or a substantially semi-circular shape, among others.

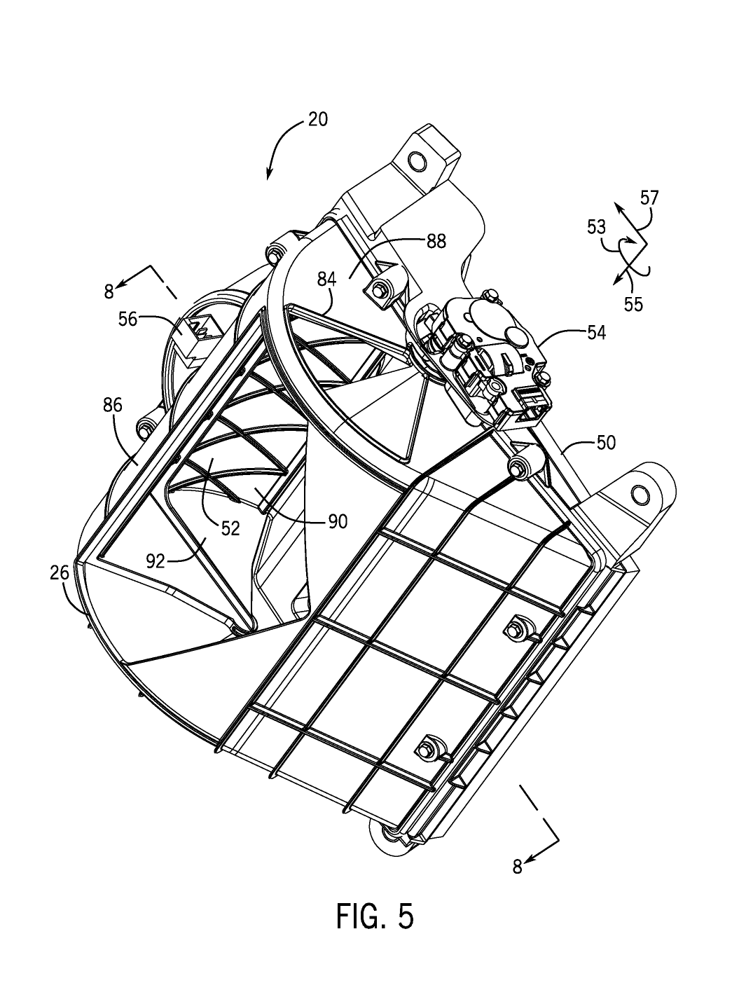

FIG. 5 is a back perspective view of the airflow control assembly 20 of FIG. 3. In the illustrated embodiment, the body 50 includes the second inlet 26 configured to receive the second airflow from the interior of the cab of the work vehicle. As previously discussed, the arcuate door 52 is configured to rotate within the body 50 to control the first airflow through the first inlet and the second airflow through the second inlet 26. In the illustrated embodiment, the body 50 also includes a third inlet 84 configured to receive the second airflow (e.g., recirculated air) from the interior of the cab of the work vehicle. Accordingly, a first portion of the recirculated air may flow through the second inlet 26 and a second portion of the recirculated air may flow through the third inlet 84.

While the third inlet 84 is substantially triangular in the illustrated embodiment, it should be appreciated that the third inlet may be another suitable shape (e.g., rectangular, circular, elliptical, etc.) in alternative embodiments. Furthermore, in certain embodiments, the third inlet may be omitted and the recirculated air may flow through the second inlet. In further embodiments, the body may include additional inlets (e.g., 3, 4, 5, 6, 7, or more) configured to receive the recirculated air (e.g., a fourth inlet positioned on an opposite longitudinal side of the body from the third inlet). In the illustrated embodiments, the second inlet 26 extends through a first wall 86 of the body 50, the third inlet 84 extends through a second wall 88 of the body 50, and the first and second walls are substantially perpendicular to one other. However, in alternative embodiments, the second and/or third inlets may extend through any suitable wall of the body.

In the illustrated embodiment, the arcuate door 52 includes a central portion 90 extending between a pair of end portions 92. As illustrated, the central portion 90 extends along the circumferential axis 53 and along the longitudinal axis 55. In addition, each end portion 92 extends along the radial axis 57 and along the circumferential axis 53. As discussed in detail below, the central portion 90 is configured to selectively block the first airflow through the first inlet and to selectively block the second airflow through the second inlet. In addition, one end portion 92 is configured to selectively block the second airflow through the third inlet. For example, as the arcuate door 52 rotates from the illustrated first position toward the second position, the central portion 90 blocks an increasing portion of the second inlet 26, and the end portion 92 blocks as increasing portion of the third inlet 84.

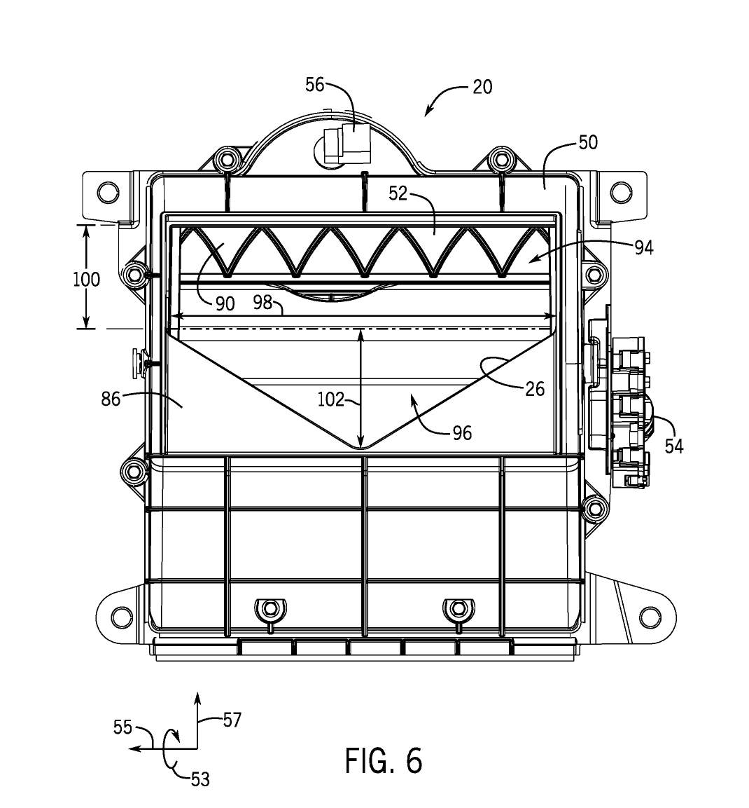

FIG. 6 is a back view of the airflow control assembly 20 of FIG. 3. As illustrated, the second inlet 26 includes a first portion 94 having a substantially rectangular shape and a second portion 96 having a substantially triangular shape. A longitudinal extent 98 (e.g., extent along the longitudinal axis 55) and a circumferential extent 100 (e.g., extent along the circumferential axis 53) of the first portion 94 may be particularly selected to establish a desired flow rate of the second airflow through the second inlet 26 (e.g., relative to a flow rate of the first airflow, based on the position of the arcuate door, etc.). In addition, a maximum circumferential extent 102 (e.g., maximum extent along the circumferential axis 53) of the second portion 96 may be particularly selected to establish a desired flow rate of the second airflow through the second inlet 26 (e.g., relative to a flow rate of the first airflow, based on the position of the arcuate door, etc.).

While the illustrated second inlet 26 includes a first portion 94 having a substantially rectangular shape and a second portion 96 having a substantially triangular shape, it should be appreciated that in alternative embodiments, the second inlet may have other shapes and/or configurations. For example, in certain embodiments, the second inlet may include a single portion (e.g., having a substantially rectangular shape, a substantially trapezoidal shape, a substantially elliptical shape, a substantially diamond-shaped shape, etc.). In further embodiments, the second inlet may include 3, 4, 5, 6, or more portions (e.g., each portion having a different shape). In addition, while the illustrated first portion has a substantially rectangular shape, it should be appreciated that in alternative embodiments, the first portion may have a substantially trapezoidal shape, a substantially semi-elliptical shape, or a substantially semi-circular shape, among others. Furthermore, while the illustrated second portion has a substantially triangular shape, it should be appreciated that in alternative embodiments, the second portion may have a substantially rectangular shape, a substantially semi-elliptical shape, or a substantially semi-circular shape, among others.

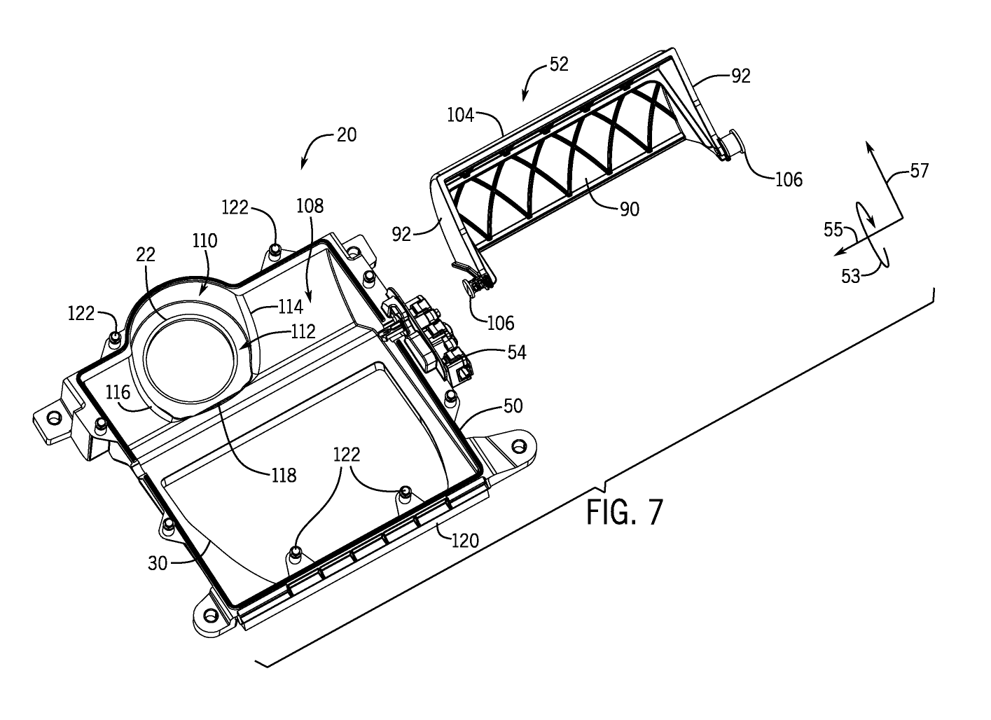

FIG. 7 is an exploded perspective view of a portion of the airflow control assembly 20 of FIG. 3. As illustrated, the arcuate door 52 includes the central portion 90 extending between the pair of end portions 92. The central portion 90 has an arcuate outer surface 104, and the central portion 90 is configured to selectively block the first airflow through the first inlet and to selectively block the second airflow through the second inlet. In the illustrated embodiment, the arcuate door 52 includes a pair of protrusions 106, each extending from a respective end portion 92 along the longitudinal axis 55. The pair of protrusions 106 is configured to support the arcuate door 52 within the body 50 and to facilitate rotation of the arcuate door 52 along the circumferential axis 53 relative to the body 50. In the illustrated embodiment, one of the protrusions 106 is configured to non-rotatably engage the actuator 54, such that the actuator 54 may drive the actuator door 52 to rotate along the circumferential axis 53 relative to the body 50.

In the illustrated embodiment, the arcuate door 52 is disposed within a main cavity 108 of the body 50. The main cavity 108 enables the arcuate door 52 to rotate between the first position and the second position, thereby controlling the first airflow through the first inlet and the second airflow through the second inlet. In addition, the body 50 forms an inlet cavity 110 at the first inlet 22. The inlet cavity 110 receives the first airflow from the inlet 22 and directs the first airflow through an opening 112 into the main cavity 108 of the body 50 (e.g., while the arcuate door is not in the first position). In the illustrated embodiment, the opening 112 is formed by a first arcuate section 114, a second arcuate section 116, a first substantially flat section 118, and a second substantially flat section. As illustrated, the first and second arcuate sections 114 and 116 form opposite longitudinal ends of the opening 112, and the first substantially flat section 118 forms a first circumferential end of the opening 112. In certain embodiments, the second substantially flat section forms a second circumferential end of the opening, opposite the first circumferential end of the opening. In the illustrated embodiment, the body is formed by a first body section 120 and a second body section, which are coupled to one another by multiple fasteners 122. In certain embodiments, the second substantially flat section is formed on the second body section of the body.

While the illustrated body is formed from two body sections coupled to one another by fasteners, it should be appreciated that in alternative embodiments, the first and second body sections may be coupled to one another by another suitable connection system, such as an adhesive connection, a welded connection, or a latching system, among others. Furthermore, in certain embodiments, the body may be formed as a unitary structure (e.g., having a single section). In further embodiments, the body may be formed from 3, 4, 5, 6, or more sections. In addition, while the opening 112 is formed by two arcuate sections and two substantially flat sections in the illustrated embodiment, it should be appreciated that in certain embodiments, the opening may be formed by other suitable sections (e.g., any suitable combination of arcuate and substantially flat sections) and/or another suitable number of sections (e.g., 1, 2, 3, 4, 5, 6, or more). Accordingly, the shape and/or size of the opening may be particular selected to establish a desired flow rate of the first airflow into the main cavity of the body (e.g., based on the position of the door, relative to a flow rate of the second airflow, etc.).

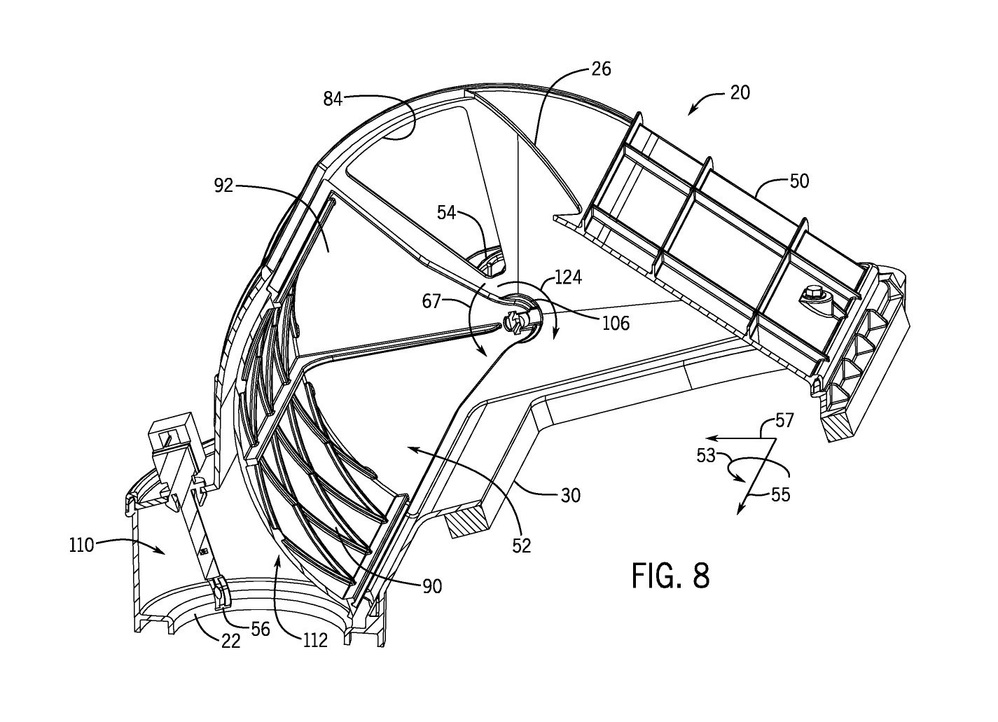

FIG. 8 is a cross-sectional perspective view of the airflow control assembly 20 of FIG. 3, taken along line 8-8 of FIG. 5, in which the arcuate door 52 is in a first position. As illustrated, the first inlet 22, the second inlet 26, and the outlet 30 are arranged along the circumferential axis 53 and spaced apart from one another along the circumferential axis. Accordingly, the arcuate door 52 may block at least a portion of the first inlet 22 and at least a portion of the second inlet 26 based on a circumferential position of the door. While the arcuate door 52 is in the illustrated first position, the central portion 90 of the arcuate door 52 substantially blocks the first airflow through the first inlet 22 (e.g., by blocking the first airflow through the opening 112). In addition, while the arcuate door 52 is in the first position, the central portion 90 of the arcuate door 52 is positioned remote from the second inlet, and the end portion 92 of the arcuate door 52 is positioned remote from the third inlet 84. Accordingly, the second airflow may flow through the second inlet 26 and the third inlet 84 to the interior of the cab. As a result, most of the airflow (e.g., about 95 percent of the airflow, about 98 percent of the airflow, about 99 percent of the airflow, about 99.5 percent of the airflow, etc.) from the airflow control assembly 20 to the interior of the cab may be recirculated air. As discussed below, rotation of the arcuate door 52 in the direction 124 may move the arcuate door toward the second position.

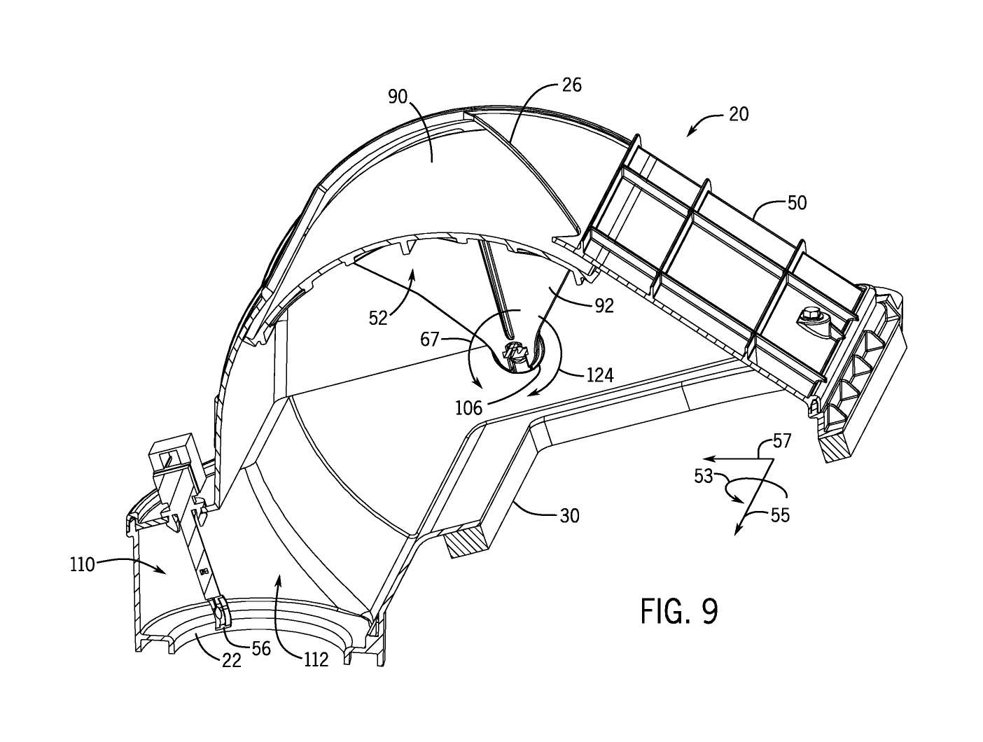

FIG. 9 is a cross-sectional perspective view of the airflow control assembly 20 of FIG. 3, in which the arcuate door 52 is in a second position. While the arcuate door 52 is in the second position, the central portion 90 of the arcuate door 52 substantially blocks the second airflow through the second inlet 26, and the end portion 92 of the arcuate door 52 substantially blocks the second airflow through the third inlet 84. In addition, while the arcuate door 52 is in the second position, the central portion 90 of the arcuate door 52 is positioned remote from the first inlet 52 (e.g., remote from the opening 112 to the inlet cavity 110). Accordingly, the first airflow may flow through the first inlet 22 to the interior of the cab. As a result, most of the airflow (e.g., about 95 percent of the airflow, about 98 percent of the airflow, about 99 percent of the airflow, about 99.5 percent of the airflow, etc.) from the airflow control assembly 20 to the interior of the cab may be external air. While the arcuate door 52 is in the second position, the arcuate door may be rotated in the direction 67 toward the first position.

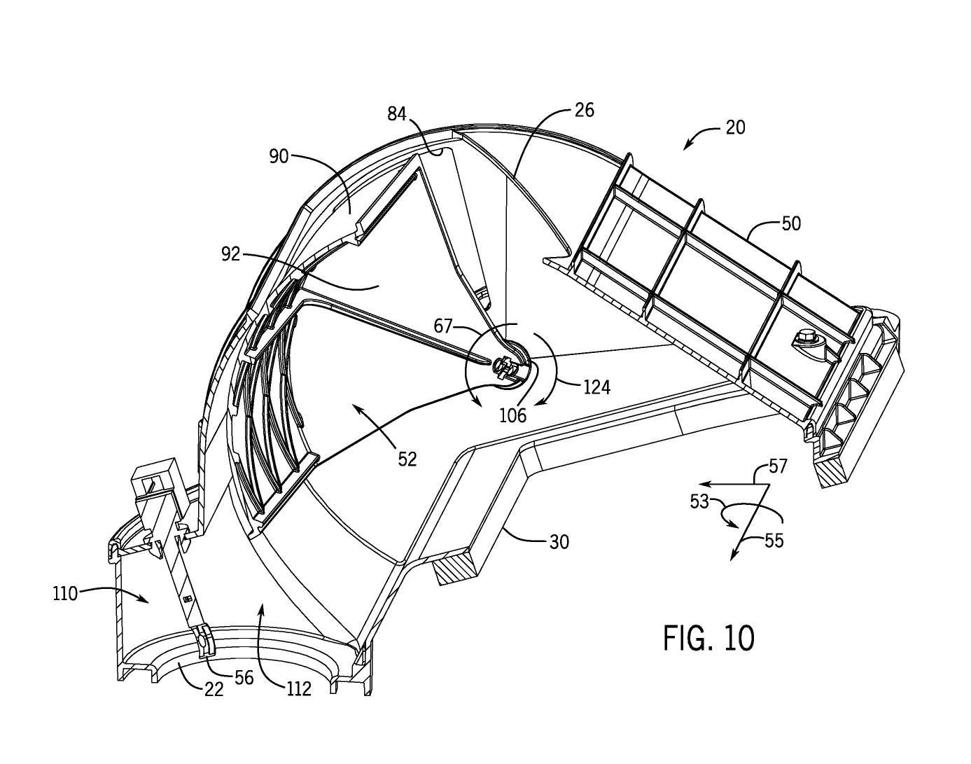

FIG. 10 is a cross-sectional perspective view of the airflow control assembly of FIG. 3, in which the arcuate door 52 is in a third position. While the arcuate door 52 is in the third position, the central portion 90 of the arcuate door 52 partially blocks the first airflow through the first inlet 22 (e.g., partially blocks the opening 112), and the central portion 90 of the arcuate door 52 partially blocks the second airflow through the second opening 26. In addition, the end portion 92 of the arcuate door 52 partially blocks the second airflow through the third opening 84. Accordingly, the airflow from the airflow control assembly 20 to the interior of the cab includes a mixture of recirculated air and external air. By rotating the arcuate door along the circumferential axis 53 (e.g., in the direction 67 or the direction 124), the mixture of recirculated air and external air may be controlled, thereby controlling the pressurization of the interior of the cab. In addition, because the width of the first inlet 22 increases from the first circumferential end to the transition point and decreases between the transition point and the second circumferential end, moving the arcuate door 52 between the first and second positions may produce a substantially linear change in cab pressurization. As a result, controlling the air pressure within the interior of the cab may be significantly less complex than controlling cab pressurization with an airflow control assembly having a non-linear relationship between door position and cab pressurization (e.g., an airflow control assembly having a body with a substantially rectangular external air inlet).

While only certain features have been illustrated and described herein, many modifications and changes will occur to those skilled in the art. It is, therefore, to be understood that the appended claims are intended to cover all such modifications and changes as fall within the true spirit of the disclosure.

1. An airflow control assembly for a heating, ventilation, and air conditioning (HVAC) system of a work vehicle, comprising:
a body having a first inlet configured to receive a first airflow from an environment external to a cab of the work vehicle, a second inlet configured to receive a second airflow from an interior of the cab of the work vehicle, and an outlet configured to output a third airflow to the interior of the cab of the work vehicle; and
an arcuate door disposed within the body, wherein the arcuate door is configured to rotate relative to the body to control the first airflow through the first inlet and the second airflow through the second inlet;
wherein a width of the first inlet increases from a first circumferential end of the first inlet to a transition point between the first circumferential end and a second circumferential end of the first inlet, and the width of the first inlet decreases from the transition point to the second circumferential end of the first inlet.

2. The airflow control assembly of claim 1, wherein the first inlet is substantially circular.

3. The airflow control assembly of claim 1, wherein at least a portion of the second inlet is substantially rectangular.

4. The airflow control assembly of claim 1, wherein the second inlet includes a first portion having a substantially rectangular shape and a second portion having a substantially triangular shape.

5. The airflow control assembly of claim 1, wherein the body has a third inlet configured to receive the second airflow, and the door is configured to control the second airflow through the second inlet and the third inlet.

6. The airflow control assembly of claim 1, wherein at least a portion of the outlet has a substantially trapezoidal shape.

7. The airflow control assembly of claim 1, wherein the arcuate door includes a central portion extending between a pair of end portions.

8. The airflow control assembly of claim 6, wherein the arcuate door comprises a pair of protrusions each extending from a respective end portion of the pair of end portions, wherein the pair of protrusions is configured to support the arcuate door within the body and to facilitate rotation of the arcuate door relative to the body.

9. The airflow control assembly of claim 1, wherein the body includes an inlet cavity extending from the first inlet.

10. The airflow control assembly of claim 1, comprising an actuator coupled to the arcuate door and configured to drive the arcuate door to rotate relative to the body.

11. An airflow control assembly for a heating, ventilation, and air conditioning (HVAC) system of a work vehicle, comprising:
a body having a first inlet configured to receive a first airflow from an environment external to a cab of the work vehicle, a second inlet configured to receive a second airflow from an interior of the cab of the work vehicle, and an outlet configured to output a third airflow to the interior of the cab of the work vehicle, wherein the first inlet, the second inlet, and the outlet are arranged along a circumferential axis of the body and are spaced apart from one another along the circumferential axis; and
an arcuate door disposed within the body, wherein the arcuate door includes a central portion extending along a longitudinal axis of the body between a pair of end portions, the arcuate door is configured to rotate relative to the body along the circumferential axis between at least a first position, a second position, and a third position, the central portion of the arcuate door is configured to substantially block the first airflow through the first inlet while the arcuate door is in the first position, the central portion of the arcuate door is configured to substantially block the second airflow through the second inlet while the arcuate door is in the second position, and the central portion of the arcuate door is configured to partially block the first airflow through the first inlet and to partially block the second airflow through the second inlet while the arcuate door is in the third position;
wherein a width of the first inlet along the longitudinal axis increases from a first circumferential end of the first inlet to a transition point between the first circumferential end and a second circumferential end of the first inlet, and the width of the first inlet along the longitudinal axis decreases from the transition point to the second circumferential end of the first inlet.

12. The airflow control assembly of claim 11, wherein the body has a third inlet configured to receive the second airflow, and one of the pair of end portions is configured to substantially block the second airflow through the third inlet while the arcuate door is in the second position.

13. The airflow control assembly of claim 11, wherein the first inlet is substantially circular.

14. The airflow control assembly of claim 11, comprising an actuator coupled to the arcuate door and configured to drive the arcuate door to rotate along the circumferential axis relative to the body.

15. An airflow control assembly for a heating, ventilation, and air conditioning (HVAC) system of a work vehicle, comprising:
a body having a first inlet configured to receive a first airflow from an environment external to a cab of the work vehicle, a second inlet configured to receive a second airflow from an interior of the cab of the work vehicle, and an outlet configured to output a third airflow to the interior of the cab of the work vehicle; and
an arcuate door disposed within the body, wherein the arcuate door is configured to rotate relative to the body between at least a first position, a second position, and a third position, the arcuate door is configured to substantially block the first airflow through the first inlet while the arcuate door is in the first position, the arcuate door is configured to substantially block the second airflow through the second inlet while the arcuate door is in the second position, and the arcuate door is configured to partially block the first airflow through the first inlet and to partially block the second airflow through the second inlet while the arcuate door is in the third position;
wherein a width of the first inlet increases from a first circumferential end of the first inlet to a transition point between the first circumferential end and a second circumferential end of the first inlet, and the width of the first inlet decreases from the transition point to the second circumferential end of the first inlet.

16. The airflow control assembly of claim 15, wherein the first inlet is substantially circular.

17. The airflow control assembly of claim 15, wherein the arcuate door includes a central portion extending between a pair of end portions.

18. The airflow control assembly of claim 17, wherein the body has a third inlet configured to receive the second airflow, and one of the pair of end portions is configured to substantially block the second airflow through the third inlet while the arcuate door is in the second position.

19. The airflow control assembly of claim 15, wherein the second inlet includes a first portion having a substantially rectangular shape and a second portion having a substantially triangular shape.

20. The airflow control assembly of claim 15, comprising an actuator coupled to the arcuate door and configured to drive the arcuate door to rotate relative to the body.
